(19) United States
(12) Patent Application Publication
(10) Pub. No.: US 2005/0265180 A1
(43) Pub. Date: Dec. 1, 2005

(54) Optical disk apparatus

(76) Inventor: Hiroyuki Kogure, Gunma (JP)

Correspondence Address: FISH & RICHARDSON P.C., P.O. BOX 1022, MINNEAPOLIS, MN, 55440-1022, US

(21) Appl. No.: 11/130,417

(22) Filed: May 17, 2005

(30) Foreign Application Priority Data
May 20, 2004 (JP) 2004-150617

(51) Int. Cl. G11B 5/09

(52) U.S. Cl. 369/47.46; 369/47.36; 369/47.1

(57) ABSTRACT

An optical disk apparatus comprises a controller that outputs a rotation control signal to rotate an optical disk medium rotating motor in a predetermined direction to a drive section that drives the rotating motor; and a determining section that determines whether the rotation control signal has been continuously output for a first predetermined period of time based on information that has been read out from an optical disk medium when the optical disk medium is being rotated by the optical disk medium rotating motor, wherein when the determining section determines that the rotation control signal has been continuously output for the first predetermined period of time, the controller stops the rotation control signal from being output for a second predetermined period of time on the basis of the determining result of the determining section.

### CROSS-REFERENCE TO RELATED APPLICATIONS

The present application claims priority from Japanese Patent Application No. 2004-150617 filed on May 20, 2004, which is herein incorporated by reference.

### BACKGROUND OF THE INVENTION

1. Field of the Invention

The present invention relates to an optical disk apparatus.

2. Description of the Related Art

Optical disk apparatuses rotate an optical disk medium at predetermined linear velocities (rotation speeds) specified in standards of optical disk media (e.g., CDs (Compact Disks), DVDs (Digital Versatile Disks)). And the optical disk apparatus playbacks data such as music or video recorded on the optical disk medium by irradiating laser light onto the optical disk medium for information playback and the like.

Here, in order to rotate an optical disk medium at predetermined linear velocities, a spindle motor (e.g., a brushless motor) is used. The optical disk apparatus rotates an optical disk medium at a predetermined linear velocity by performing spindle servo control to drive the spindle motor in a predetermined rotation direction and at a predetermined rotation speed.

To describe in detail, the optical disk apparatus is provided with a spindle servo processing section that performs spindle servo control based on information such as an RF signal obtained from reflected light from the optical disk medium. First, this spindle servo processing section detects the linear velocity of the optical disk medium based on information obtained from reflected light from the optical disk medium. Then, the spindle servo processing section determines whether the linear velocity of the optical disk medium is faster or slower than a predetermined linear velocity. For example, when determining that the linear velocity of the optical disk medium is slower than the predetermined linear velocity, the spindle servo processing section generates a rotation control signal to accordingly accelerate the rotation speed of the spindle motor. Then, a voltage based on the rotation control signal is applied to the coil of the spindle motor. Applying the voltage to the coil makes the spindle motor accelerate in a predetermined rotation direction, thereby accelerating the optical disk medium to the predetermined linear velocity. On the other hand, when determining that the linear velocity of the optical disk medium is faster than the predetermined linear velocity, the spindle servo processing section generates a rotation control signal to accordingly decelerate the rotation speed of the spindle motor. Then, a voltage based on the rotation control signal is applied to the coil of the spindle motor. Applying the voltage to the coil makes the spindle motor accelerate in a direction opposite to the predetermined rotation direction, thereby decelerating the optical disk medium to the predetermined linear velocity. See, for example, Japanese Patent Application Laid-open Publication No. 2001-202688.

However, when the linear velocity of the optical disk medium is slower than the predetermined linear velocity and the velocity difference between them is large, the coil of the spindle motor continues to have applied thereto a voltage based on the above-mentioned rotation control signal according to acceleration. And when the linear velocity of the optical disk medium is faster than the predetermined linear velocity and the velocity difference between them is large, the coil of the spindle motor continues to have applied thereto a voltage based on the above-mentioned rotation control signal according to deceleration. In particular, when activating the optical disk apparatus, in order to have the optical disk medium reach the predetermined linear velocity, the coil of the spindle motor continues to have applied thereto a voltage of a level based on the rotation control signal according to acceleration for a certain period of time. Hence, the coil of the spindle motor generates heat, which is a burden on the coil. Thus, the problem occurs that the heat damages the coil of the spindle motor, thereby shortening the product lifetime of the spindle motor.

### SUMMARY OF THE INVENTION

An object of the present invention is to provide an optical disk apparatus which can reduce the burden on the spindle motor due to the rotation control signal.

According to one aspect of the present invention, there is provided an optical disk apparatus comprising a controller that outputs a rotation control signal to rotate an optical disk medium rotating motor in a predetermined direction to a drive section that drives the rotating motor, and a determining section that determines whether the rotation control signal has been continuously output for a first predetermined period of time based on information that has been read out from an optical disk medium when the optical disk medium is being rotated by the optical disk medium rotating motor, wherein when the determining section determines that the rotation control signal has been continuously output for the first predetermined period of time, the controller stops the rotation control signal from being output for a second predetermined period of time on the basis of the determining result of the determining section.

According to the present invention, there is provided an optical disk apparatus which can reduce the burden on the spindle motor due to the rotation control signal.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a function block diagram illustrating the whole of an optical disk playback apparatus according to the present invention;

FIG. 2 is a flow chart illustrating the processing operation of a spindle servo processing section;

FIG. 3 is a diagram showing an example of the configuration of a spindle control signal processing section;

FIG. 4 is a flow chart of the control by a comparison controller of the spindle control signal processing section;

FIG. 5 is a table showing the comparing results of the comparison controller;

FIG. 6 is a voltage waveform diagram showing analog values output from a D/A converter to a driver; and

FIG. 7 shows a relationship between Vref (1.65 volts) and 8-bit data in the 2's complement notation.

### DETAILED DESCRIPTION OF THE INVENTION

At least the following matters will be made clear by the explanation in the present specification and the description of the accompanying drawings.

==Whole Configuration of an Optical Disk Playback Apparatus==

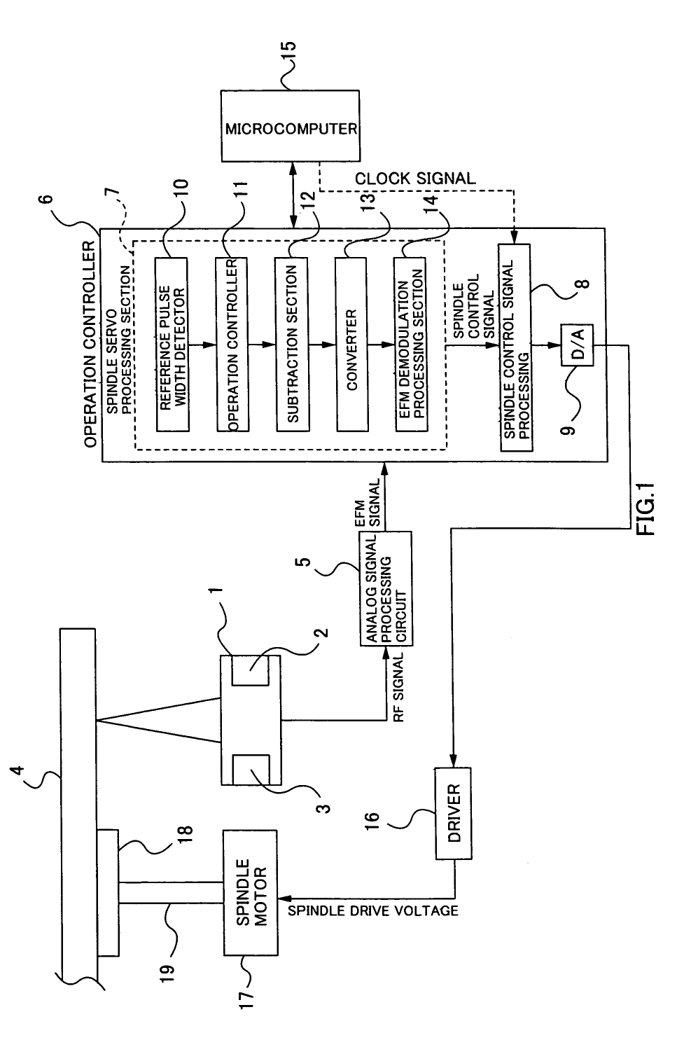

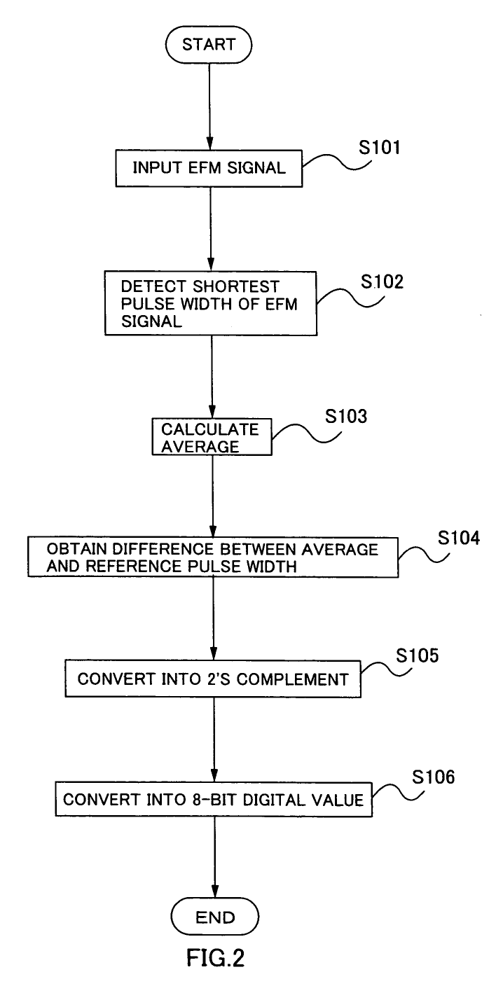

The whole configuration of an optical disk playback apparatus to which the present invention for an optical disk apparatus is applied will be described with reference to FIGS. 1 and 2. FIG. 1 is a function block diagram illustrating the whole of the optical disk playback apparatus to which the present invention for an optical disk apparatus is applied. FIG. 2 is a flow chart showing the operation of a spindle servo processing section 7 (a controller). In the description of this embodiment, when rotating an optical disk medium at a predetermined linear velocity, the drive force of the spindle motor to accelerate the optical disk medium is called a positive drive force, and the drive force of the spindle motor to decelerate the optical disk medium is called a negative drive force. And the “h” in an FFh signal and a 00h signal indicates that the number is in hexadecimal.

In FIG. 1, an optical pickup 1 comprises a laser diode 2 and a photo-detector 3. The optical pickup irradiates laser light emitted from the laser diode 2 as a light source onto an optical disk medium 4 through an objective lens (not shown). The photo-detector 3 receives a light of the laser light reflected from the optical disk medium 4, and generates an RF (Radio Frequency) signal based on the reflected light. This RF signal is generated by performing an operation according to a DPD (Differential Phase Detection) method based on the reflected light received by the photo-detector 3.

An analog signal processing circuit 5 gain-controls the RF signal from the optical pickup 1 to an optimum level, while binarizing the gain-controlled RF signal with a predetermined slice level to produce an EFM (Eight to Fourteen Modulation) signal of 14 bits in length.

An operation controller 6 comprises the spindle servo processing section 7, a spindle control signal processing section 8 (a controller and determining section), and a D/A converter 9.

The spindle servo processing section 7 comprises a reference pulse width detector 10, an operation section 11, a subtraction section 12, a converter 13, and an EFM demodulation processing section 14, and has the EFM signal inputted from the analog signal processing circuit 5 (S101 in FIG. 2). The reference pulse width detector 10 detects, for example, the shortest pulse width from among the high level pulse widths of the EFM signal in a predetermined period of time (S102 in FIG. 2). The operation section 11 calculates the average of the shortest pulse width in the predetermined period of time and the respective shortest pulse widths detected likewise from among the high level pulse widths of the EFM signal in two predetermined periods of time preceding the predetermined period of time (S103 in FIG. 2). The subtraction section 12 detects the difference as a digital value between the average of pulse widths of the EFM signal calculated by the operation section 11 and a reference pulse width stored beforehand in a RAM or the like (not shown) in a microcomputer 15 (S104 in FIG. 2). This reference pulse width is predefined according to a standard for optical disk media 4, and for example, for CDs, is 3T to 11T (1T=4.3218 MHz). That is, if the above average of pulse widths of the EFM signal is at the reference pulse width, it means that the optical disk medium 4 is rotating at the predetermined linear velocity. If the above average of pulse widths of the EFM signal is shorter than the reference pulse width, it means that the optical disk medium 4 is rotating faster than at the predetermined linear velocity. If the above average of pulse widths of the EFM signal is longer than the reference pulse width, it means that the optical disk medium 4 is rotating slower than at the predetermined linear velocity. The converter 13 converts the digital value, representing the difference between the above average of pulse widths of the EFM signal calculated by the operation section 11 and the reference pulse width, into a 2's complement (S105 in FIG. 2). The EFM demodulation processing section 14 converts the 2's complemented digital value into an 8-bit digital value (S106 in FIG. 2).

The microcomputer 15 controls the whole optical disk playback apparatus associated with the playback and the like of data recorded on the optical disk medium 4. The microcomputer 15 generates a 2's complemented 8-bit spindle control signal (rotation control signal) according to the difference between the above average of pulse widths of the EFM signal and the reference pulse width based on the 8-bit digital value converted into by the EFM demodulation processing section 14 of the spindle servo processing section 7, in order to rotate the optical disk medium 4 at the predetermined linear velocity. Also, the microcomputer 15 outputs to the spindle control signal processing section 8 a clock signal of a predetermined frequency (e.g. 11 kHz) as timings when the processing section 8 performs processing.

The spindle control signal processing section 8 determines whether to drive the spindle motor 17 (an optical disk rotation motor) in a predetermined rotation direction and at a predetermined rotation speed according to the spindle control signal from the spindle servo processing section 7 as described later, and outputs to the D/A converter 9 one of the spindle control signal, the 00h signal (drive force stop signal), and the FFh signal (reverse rotation control signal) depending on the determining result.

The D/A converter 9 converts the spindle control signal, the 00h signal, and the FFh signal from the spindle control signal processing section 8 into an analog value.

A driver 16 (a drive section) amplifies the analog value from the D/A converter 9 with a predetermined factor to produce a spindle drive voltage.

A turn table 18 is secured to a rotation shaft 19 of the spindle motor 17. The spindle motor 17 has a spindle motor coil (not shown), and rotates in a predetermined rotation direction and at a predetermined rotation speed by the spindle drive voltage from the driver 16 being applied to the spindle motor coil.

===Exemplary Configuration of the Spindle Control Signal Processing Section===

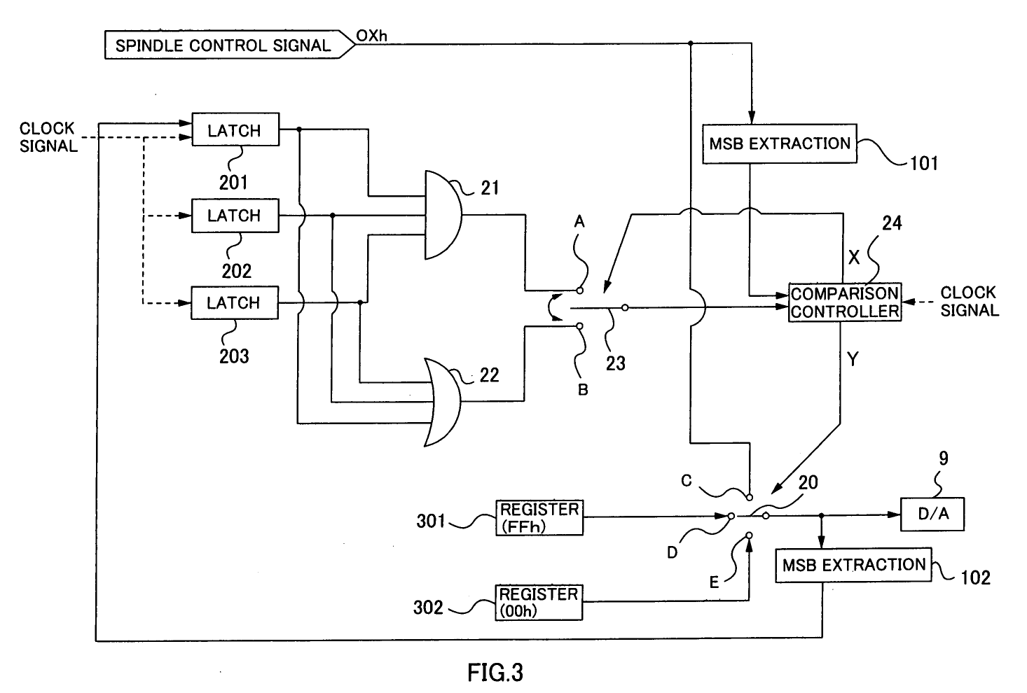

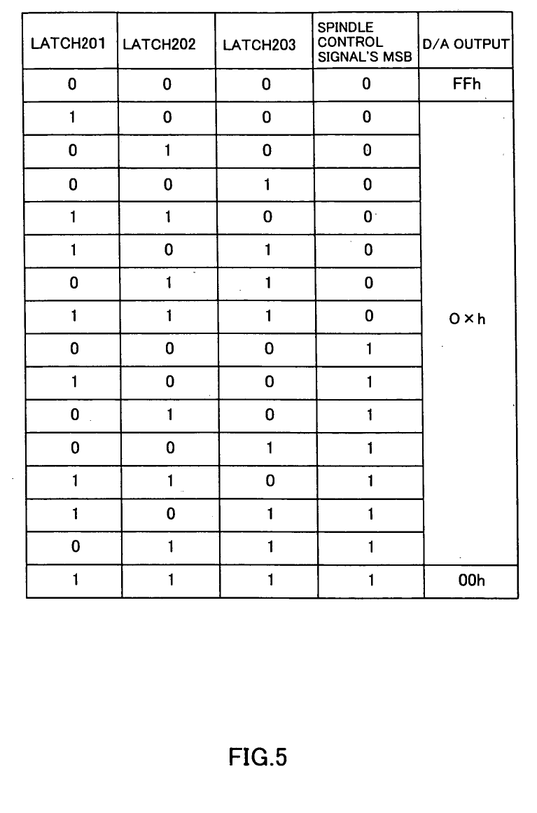

The spindle control signal processing section of the optical disk apparatus according to an embodiment of the present invention will be described with reference to FIGS. 1, 3, and 7. FIG. 3 is a diagram illustrating an example of the configuration of the spindle control signal processing section 8 of FIG. 5. FIG. 7 shows a relationship between Vref (1.65 volts) and 8-bit data in the 2's complement notation. In the description of this embodiment, three latch circuits 201, 202, 203 are provided to store at three consecutive timings the spindle control signal, the 00h signal, or the FFh signal to be output to the D/A converter 9.

The spindle control signal processing section 8 comprises an MSB extraction section 101 (a second extraction section), an MSB extraction section 102 (a first extraction section), the latch circuits 201, 202, 203 (storage section), a logical product circuit 21 (a logic circuit), a logical sum circuit 22 (a logic circuit), a comparison controller 24 (a comparison controller), a selector switch 23, a selector switch 20 (a selector), and registers 301, 302.

The MSB extraction section 102 extracts the most significant bit of the spindle control signal, the FFh signal, or the 00h signal output from the selector switch 20.

The latch circuit 201 has the clock signal of the predetermined frequency inputted from the microcomputer 15, and stores a most significant bit extracted by the MSB extraction section 102. The latch circuit 202 has the clock signal of the predetermined frequency inputted from the microcomputer 15, and stores the most significant bit from the latch circuit 201 at the same timing as the latch circuit 201 stores a most significant bit from the MSB extraction section 102. The latch circuit 203 has the clock signal of the predetermined frequency inputted from the microcomputer 15, and stores the most significant bit from the latch circuit 202 at the same timing as the latch circuit 201 stores a most significant bit from the MSB extraction section 102.

The logical product circuit 21 outputs “1” when the most significant bits stored in the latch circuits 201, 202, 203 are all “1”, and outputs “0” when at least one of the most significant bits stored in the latch circuits 201, 202, 203 is “0”.

The logical sum circuit 22 outputs “0” when the most significant bits stored in the latch circuits 201, 202, 203 are all “0”, and outputs “1” when at least one of the most significant bits stored in the latch circuits 201, 202, 203 is “1”.

The MSB extraction section 101 extracts the most significant bit of the spindle control signal (denoted by OXh in FIG. 3) output from the spindle servo processing section 7.

When a selection signal X is not supplied from the comparison controller 24, one end of the selector switch 23 is connected to neither of contact points A, B. The other end is connected to an input of the comparison controller 24. The one end of the selector switch 23 is connected to one of the contact points A, B depending on the selection signal X from the comparison controller 24.

When a selection signal Y is not supplied from the comparison controller 24, one end of the selector switch 20 is connected to none of contact points C, D, E. The other end is connected to the D/A converter 9 and the MSB extraction section 102. The one end of the selector switch 20 is connected to one of the contact points C, D, E depending on the selection signal Y from the comparison controller 24.

The comparison controller 24 supplies the selector switch 23 with the selection signal X to cause the one end of the selector switch 23 to be connected to the contact point A when the most significant bit of the spindle control signal extracted by the MSB extraction section 101 is “1” and when “0”, to cause the one end of the selector switch 23 to be connected to the contact point B. And when the one end of the selector switch 23 is connected to the contact point A and the output of the logical product circuit 21 is at “1”, the comparison controller 24 supplies the selector switch 20 with the selection signal Y to cause the one end of the selector switch 20 to be connected to the contact point E. In contrast, when the one end of the selector switch 23 is connected to the contact point A and the output of the logical product circuit 21 is at “0”, the comparison controller 24 supplies the selector switch 20 with the selection signal Y to cause the one end of the selector switch 20 to be connected to the contact point C. On the other hand, when the one end of the selector switch 23 is connected to the contact point B and the output of the logical sum circuit 22 is at “1”, the comparison controller 24 supplies the selector switch 20 with the selection signal Y to cause the one end of the selector switch 20 to be connected to the contact point C. In contrast, when the one end of the selector switch 23 is connected to the contact point B and the output of the logical sum circuit 22 is at “0”, the comparison controller 24 supplies the selector switch 20 with the selection signal Y to cause the one end of the selector switch 20 to be connected to the contact point D. Furthermore, the comparison controller 24 has the clock signal of the predetermined frequency inputted from the microcomputer 15 as the latch circuits 201, 202, 203 have, and performs the above processing at the same timings as the latch circuits 201, 202, 203.

The register 301 holds the FFh signal, and is connected to the contact point D. When the one end of the selector switch 20 is connected to the contact point D, the FFh signal is supplied to the D/A converter 9. Note that the register 301 may have the FFh signal inputted from the microcomputer 15 at the start of the optical disk apparatus to hold it, or may have the FFh signal recorded therein in a fixed manner. Alternatively, without the register 301, the microcomputer 15 may supply the FFh signal directly.

The register 302 holds the 00h signal, and is connected to the contact point E. When the one end of the selector switch 20 is connected to the contact point E, the 00h signal is supplied to the D/A converter 9. Note that the register 302 may have the 00h signal inputted from the microcomputer 15 at the start of the optical disk apparatus to hold it, or may have the 00h signal recorded therein in a fixed manner. Alternatively, without the register 302, the microcomputer 15 may supply the 00h signal directly.

The FFh in the FFh signal is a value that corresponds to a voltage of about Vref (1.65 volts) when converted into an analog value by the D/A converter 9 as shown in FIG. 7. The 00h in the 00h signal is a value that corresponds to a voltage of Vref (1.65 volts) when converted into an analog value by the D/A converter 9 as shown in FIG. 7. A spindle drive voltage applied to the spindle motor coil of the spindle motor 17 via the driver 16 is at the Vref (1.65 volts) at convergence. The spindle motor 17 is designed such that when the spindle drive voltage is at the Vref (1.65 volts), the burden on the spindle motor coil is minimized.

===Operation of the Optical Disk Apparatus===

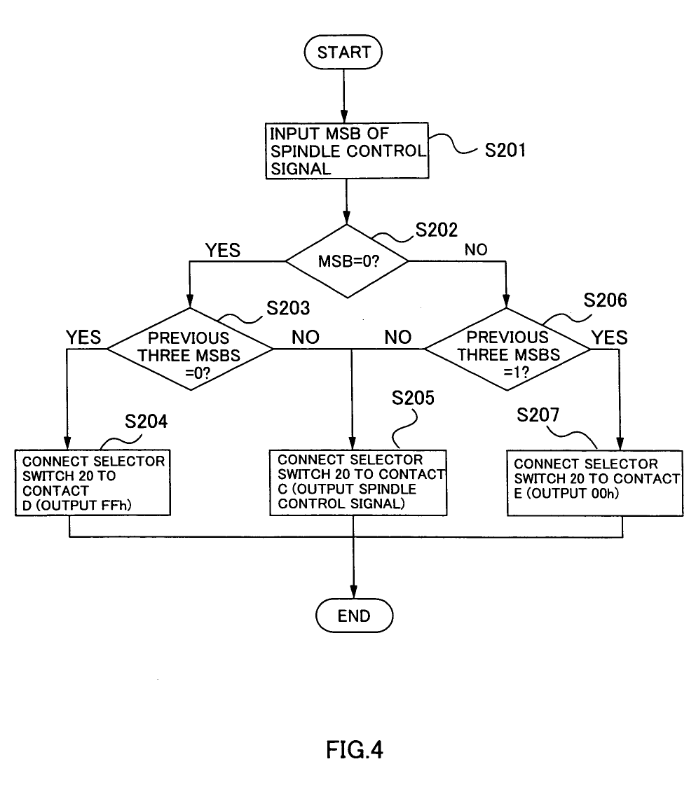

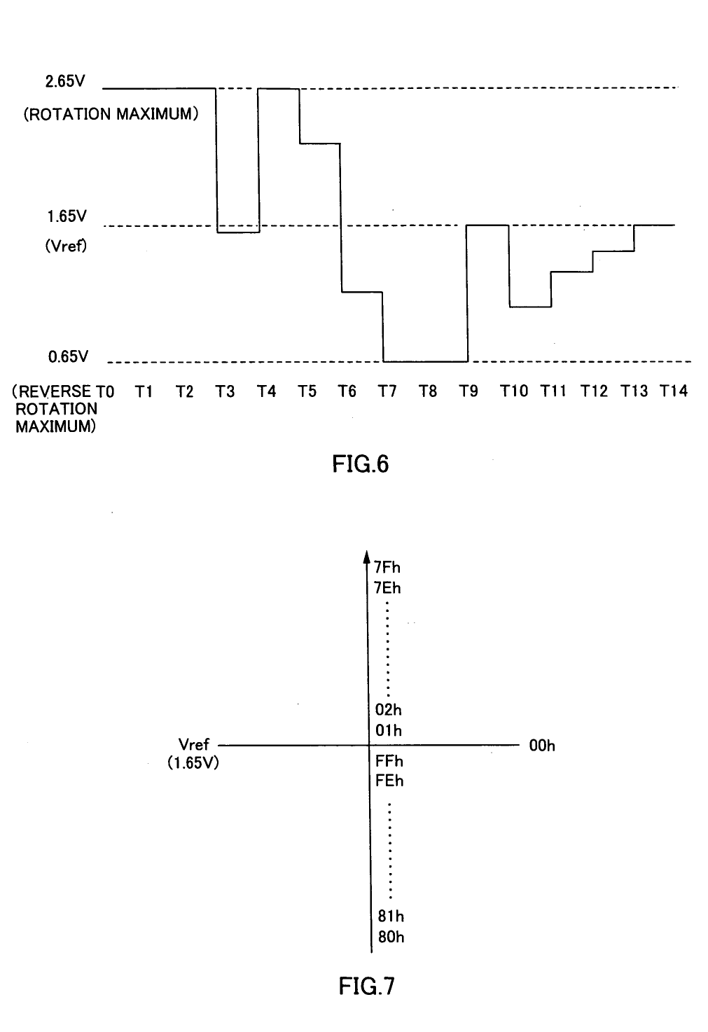

The operation of the optical disk apparatus according to one embodiment of the present invention, particularly, the control of the spindle motor by the spindle control signal processing section will be described with reference to FIGS. 1 to 6. FIG. 4 is a flow chart of the control by the comparison controller of the spindle control signal processing section. FIG. 5 is a table showing the comparing results of the comparison controller. FIG. 6 is a voltage waveform diagram showing analog values output from the D/A converter to the driver. In the description of this embodiment, the most significant bit of the spindle control signal to generate a positive drive force in the spindle motor 17 is “0” and the most significant bit of the spindle control signal to generate a negative drive force is “1”.

First, the case where the most significant bits of the spindle control signal stored in the latch circuits 201, 202, 203 are all “0” will be described. For example, in FIG. 6 for a predetermined period of time from T0 to T3, the T0 indicating the start of the optical disk apparatus, the spindle control signal to generate a positive drive force of the spindle motor 17 is output to the D/A converter 9 so as to rotate an optical disk medium at a predetermined rotation speed. Hence, the latch circuit 201 at timing T2 in FIG. 6 stores the most significant bit “0” of the spindle control signal extracted by the MSB extraction section 102. The latch circuit 202 at timing T2 in FIG. 6 stores the most significant bit “0” of the spindle control signal extracted by the MSB extraction section 102 and stored at timing T1 by the latch circuit 201. The latch circuit 203 at timing T2 in FIG. 6 stores the most significant bit “0” of the spindle control signal extracted at timing T0 by the MSB extraction section 102 and stored at timing T1 by the latch circuit 202.

The spindle servo processing section 7 calculates the 2's complemented 8-bit digital value, representing the difference between the average of pulse widths of the EFM signal and the reference pulse width based on the EFM signal from the analog signal processing circuit 5 (S101 through S106 in FIG. 2). The microcomputer 15 generates the spindle control signal (OXh in FIGS. 3, 5) according to the difference between the average of pulse widths of the EFM signal and the reference pulse width based on the 8-bit digital value in order to rotate the optical disk medium at the predetermined linear velocity. In the description of the present embodiment, it is assumed that the optical disk medium 4 is not made to reach the predetermined linear velocity by positive drive forces generated by the spindle control signals output to the D/A converter 9 at timings T0, T1, T2.

The MSB extraction section 101 at timings T3 in FIG. 6 extracts the most significant bit “0” of the spindle control signal. The comparison controller 24 has inputted thereto the most significant bit “0” of the spindle control signal extracted by the MSB extraction section 101 (S201 in FIG. 4). When the comparison controller 24 determines that the most significant bit of the spindle control signal is “0” (YES in S202 of FIG. 4), the comparison controller 24 supplies the selector switch 23 with the selection signal X to cause the one end of the selector switch 23 to be connected to the contact point B. The one end of the selector switch 23 is connected to the contact point B on the basis of the selection signal X. The logical sum circuit 22 outputs a “0” to the comparison controller 24 via the selector switch 23 because the most significant bits stored in the latch circuits 201, 202, 203 are all “0”, as above. When the comparison controller 24 determines that the output of the logical sum circuit 22 is “0” (YES in S203 of FIG. 4), the comparison controller 24 supplies the selector switch 20 with the selection signal Y to cause the one end of the selector switch 20 to be connected to the contact point D (S204 of FIG. 4). The one end of the selector switch 20 is connected to the contact point D on the basis of the selection signal Y. The FFh signal held in the register 301 is output to the D/A converter 9 via the selector switch 20. The D/A converter 9 converts the FFh signal into an analog value of about 1.65 volts (see between T3 and T4 in FIG. 6). The driver 16 amplifies the analog value from the D/A converter 9 with a predetermined factor to produce a spindle drive voltage. The spindle drive voltage is applied to the spindle motor coil of the spindle motor 17.

That is, in the interval between T3 and T4 in FIG. 6, the burden of the spindle drive voltage on the spindle motor coil is smallest. The MSB extraction section 102 at timings T3 in FIG. 6 extracts the most significant bit “1” of the FFh signal. The latch circuit 201 stores the most significant bit “1” of the FFh signal extracted by the MSB extraction section 102. The latch circuit 202 at timing T3 in FIG. 6 stores the most significant bit “0” of the spindle control signal extracted by the MSB extraction section 102 and stored at timing T2 by the latch circuit 201. The latch circuit 203 at timing T3 in FIG. 6 stores the most significant bit “0” of the spindle control signal extracted at timing T1 by the MSB extraction section 102 and stored at timing T2 by the latch circuit 202.

Note that the logical sum circuit 22 outputs a “1” to the comparison controller 24 when at least one of the most significant bits stored in the latch circuits 201, 202, 203 is “1”. When the comparison controller 24 determines that the output of the logical sum circuit 22 is “1” (NO in S203 of FIG. 4), the comparison controller 24 supplies the selector switch 20 with the selection signal Y to cause the one end of the selector switch 20 to be connected to the contact point C (S205 of FIG. 4). The one end of the selector switch 20 is connected to the contact point C on the basis of the selection signal Y. Then, the spindle control signal generated by the spindle servo processing section 7 according to the difference between the average of pulse widths of the EFM signal and the reference pulse width is output to the D/A converter 9 via the selector switch 20. The D/A converter 9 converts the spindle control signal into an analog value (see between T4 and T5 in FIG. 6). The driver 16 amplifies the analog value from the D/A converter 9 with a predetermined factor to produce a spindle drive voltage. The spindle drive voltage is applied to the spindle motor coil of the spindle motor 17.

That is, in the interval between T4 and T5 in FIG. 6, a positive drive force is generated in the spindle motor coil. The MSB extraction section 102 at timings T4 in FIG. 6 extracts the most significant bit “0” of the spindle control signal. The latch circuit 201 stores the most significant bit “0” of the spindle control signal extracted by the MSB extraction section 102. The latch circuit 202 at timing T4 in FIG. 6 stores the most significant bit “1” of the spindle control signal extracted by the MSB extraction section 102 and stored at timing T3 by the latch circuit 201. The latch circuit 203 at timing T4 in FIG. 6 stores the most significant bit “0” of the spindle control signal extracted at timing T2 by the MSB extraction section 102 and stored at timing T3 by the latch circuit 202.

Next, the case where the most significant bits of the spindle control signal stored in the latch circuits 201, 202, 203 are all “1” will be described. The latch circuit 201 at, for example, timing T8 in FIG. 6 stores the most significant bit “1” of the spindle control signal extracted by the MSB extraction section 102. The latch circuit 202 at timing T8 in FIG. 6 stores the most significant bit “1” of the spindle control signal extracted by the MSB extraction section 102 and stored at timing T7 by the latch circuit 201. The latch circuit 203 at timing T8 in FIG. 6 stores the most significant bit “1” of the spindle control signal extracted at timing T6 by the MSB extraction section 102 and stored at timing T7 by the latch circuit 202.

The spindle servo processing section 7 calculates the 2's complemented 8-bit digital value, representing the difference between the average of pulse widths of the EFM signal and the reference pulse width based on the EFM signal from the analog signal processing circuit 5 (see S101 through S106 in FIG. 2). The microcomputer 15 generates the spindle control signal according to the difference between the average of pulse widths of the EFM signal and the reference pulse width based on the 8-bit digital value in order to rotate the optical disk medium at the predetermined linear velocity. In the description of the present embodiment, it is assumed that the optical disk medium 4 is not made to reach the predetermined linear velocity by negative drive forces generated by the spindle control signals output to the D/A converter 9 at timings T6, T7, T8.

The MSB extraction section 101 extracts the most significant bit “1” of the spindle control signal. The comparison controller 24 has inputted thereto the most significant bit “1” of the spindle control signal extracted by the MSB extraction section 101 (S201 in FIG. 4). When the comparison controller 24 determines that the most significant bit of the spindle control signal is “1” (NO in S202 of FIG. 4), the comparison controller 24 supplies the selector switch 23 with the selection signal X to cause the one end of the selector switch 23 to be connected to the contact point A. The one end of the selector switch 23 is connected to the contact point A on the basis of the selection signal X. The logical product circuit 21 outputs a “1” to the comparison controller 24 via the selector switch 23 because the most significant bits stored in the latch circuits 201, 202, 203 are all “1”, as above. When the comparison controller 24 determines that the output of the logical product circuit 21 is “1” (YES in S206 of FIG. 4), the comparison controller 24 supplies the selector switch 20 with the selection signal Y to cause the one end of the selector switch 20 to be connected to the contact point E (S207 of FIG. 4). The one end of the selector switch 20 is connected to the contact point E on the basis of the selection signal Y. The 00h signal held in the register 301 is output to the D/A converter 9 via the selector switch 20. The D/A converter 9 converts the 00h signal into an analog value of 1.65 volts (see between T9 and T10 in FIG. 6). The driver 16 amplifies the analog value from the D/A converter 9 with the predetermined factor to produce a spindle drive voltage. The spindle drive voltage is applied to the spindle motor coil of the spindle motor 17.

That is, in the interval between T9 and T10 in FIG. 6, the burden of the spindle drive voltage on the spindle motor coil is smallest. The MSB extraction section 102 at timings T9 in FIG. 6 extracts the most significant bit “0” of the 00h signal. The latch circuit 201 stores the most significant bit “0” of the 00h signal extracted by the MSB extraction section 102. The latch circuit 202 at timing T9 in FIG. 6 stores the most significant bit “1” of the spindle control signal extracted by the MSB extraction section 102 and stored at timing T8 by the latch circuit 201. The latch circuit 203 at timing T9 in FIG. 6 stores the most significant bit “1” of the spindle control signal extracted at timing T7 by the MSB extraction section 102 and stored at timing T8 by the latch circuit 202.

Note that the logical product circuit 21 outputs a “0” to the comparison controller 24 when at least one of the most significant bits stored in the latch circuits 201, 202, 203 is “0”. When the comparison controller 24 determines that the output of the logical sum circuit 22 is “0” (NO in S206 of FIG. 4), the comparison controller 24 supplies the selector switch 20 with the selection signal Y to cause the one end of the selector switch 20 to be connected to the contact point C (S205 of FIG. 4). The one end of the selector switch 20 is connected to the contact point C on the basis of the selection signal Y. Then, the spindle control signal generated by the spindle servo processing section 7 according to the difference between the average of pulse widths of the EFM signal and the reference pulse width is output to the D/A converter 9 via the selector switch 20. The D/A converter 9 converts the spindle control signal into an analog value (see between T10 and T11 in FIG. 6). The driver 16 amplifies the analog value from the D/A converter 9 with the predetermined factor to produce a spindle drive voltage. The spindle drive voltage is applied to the spindle motor coil of the spindle motor 17.

That is, in the interval between T10 and T11 in FIG. 6, a negative drive force is generated in the spindle motor coil. The MSB extraction section 102 at timings T10 in FIG. 6 extracts the most significant bit “1” of the spindle control signal. The latch circuit 201 stores the most significant bit “1” of the spindle control signal extracted by the MSB extraction section 102. The latch circuit 202 at timing T10 in FIG. 6 stores the most significant bit “0” of the spindle control signal extracted by the MSB extraction section 102 and stored at timing T9 by the latch circuit 201. The latch circuit 203 at timing T10 in FIG. 6 stores the most significant bit “1” of the spindle control signal extracted at timing T8 by the MSB extraction section 102 and stored at timing T9 by the latch circuit 202.

According to the present embodiment, in the case where for a predetermined period of time (e.g., between T0 and T3 in FIG. 6), the spindle control signal to generate a positive (or negative) drive force of the spindle motor 17 is continuously output, it is possible to stop the spindle control signal to generate a positive (or negative) drive force of the spindle motor 17 from being further output to the D/A converter 9. Thus, without the spindle motor 17 being affected by a drive force according to the spindle control signal, the burden on the spindle motor 17 can be reduced.

Furthermore, according to the present embodiment, in the case where for a predetermined period of time (e.g., between T4 and T7 in FIG. 6), the spindle control signal to generate a drive force of the same polarity in the spindle motor 17 is not continuously output, the spindle control signal generated according to the difference between the average of pulse widths of the EFM signal and the reference pulse width is enabled to be output to the D/A converter 9 after the predetermined period of time.

Moreover, according to the present embodiment, in the case where for a predetermined period of time (e.g., between T6 and T9 in FIG. 6) the spindle control signal to generate a negative drive force of the spindle motor 17 is continuously output, the spindle drive voltage of 1.65 volts based on the 00h signal is thereafter applied to the spindle motor coil of the spindle motor 17, and thus, the burden on the spindle motor 17 can be reduced most.

Further, according to the present embodiment, the 00h signal or the spindle control signal to generate a negative drive force of the spindle motor 17 output to the D/A converter 9 can be stored in the latch circuits 201, 202, 203 at plural timings. Yet further, on the basis of data stored in the latch circuits 201, 202, 203, the logical product circuit 21 can determine whether the spindle control signal has been output at plural timings.

According to the present embodiment, when detecting that the spindle control signal to generate a negative drive force of the spindle motor 17 has been output at consecutive plural timings, the logical product circuit 21 outputs one logical value of “1”, providing the detecting result of the logical product circuit 21 in simple expression. Further, it can be made sure that the 00h signal is output to the D/A converter 9. Moreover, when detecting that the 00h signal or the spindle control signal to generate a positive drive force of the spindle motor 17 was output at least at one timing of the plural timings, the logical product circuit 21 outputs the other logical value of “0”, providing the detecting result of the logical product circuit 21 in simple expression. Further, it can be made sure that the spindle control signal is output to the D/A converter 9.

According to the present embodiment, on the basis of the detecting result of the logical product circuit 21, it can be determined whether the spindle control signal to generate a negative drive force of the spindle motor 17 is to be output at timing following the plural timings. That is, when the output of the logical product circuit 21 is at the other logical value of “0”, the one end of the selector switch 20 is connected to the contact point C, thereby certainly outputting the spindle control signal to the D/A converter 9. In contrast, when the output of the logical product circuit 21 is at the one logical value of “1”, the one end of the selector switch 20 is connected to the contact point E, thereby certainly outputting the 00h signal to the D/A converter 9.

Further, according to the present embodiment, since the spindle control signal to generate a negative drive force and the 00h signal are of a digital value, it can be easily performed that the most significant bit “1” of the spindle control signal and the most significant bit “0” of the 00h signal are extracted by the MSB extraction sections 101, 102 and stored in the latch circuits 201, 202, 203 and determined by the comparison controller 24.

Still further, according to the present embodiment, in the case where for a predetermined period of time (e.g., between T0 and T3 in FIG. 6) the spindle control signal to generate a positive drive force of the spindle motor 17 is continuously output, the spindle drive voltage of about 1.65 volts based on the FFh signal is thereafter applied to the spindle motor 17, and thus the burden on the spindle motor 17 can be reduced.

Yet further, according to the present embodiment, the FF signal or the spindle control signal to generate a positive drive force of the spindle motor 17 output to the D/A converter 9 can be stored at plural timings in the latch circuits 201, 202, 203, and on the basis of data stored in the latch circuits 201, 202, 203, the logical sum circuit 22 can detect whether the spindle control signal has been output at consecutive plural timings.

According to the present embodiment, when detecting that the spindle control signal to generate a positive drive force of the spindle motor 17 has been output at consecutive plural timings, the logical sum circuit 22 outputs the one logical value of “0”, providing the detecting result of the logical sum circuit 22 in simple expression. Further, it can be made sure that the FFh signal is output to the D/A converter 9. Moreover, when detecting that the FFh signal or the spindle control signal to generate a negative drive force of the spindle motor 17 was output at least at one timing of the plural timings, the logical sum circuit 22 outputs the other logical value of “1”, providing the detecting result of the logical sum circuit 22 in simple expression. Further, it can be made sure that the spindle control signal to generate a positive drive force of the spindle motor 17 is output to the D/A converter 9.

Furthermore, according to the present embodiment, on the basis of the detecting result of the logical sum circuit 22, it can be determined whether the spindle control signal to generate a positive drive force of the spindle motor 17 is to be output at timing following the plural timings. That is, when the output of the logical sum circuit 22 is at the other logical value of “1”, the one end of the selector switch 20 is connected to the contact point C, thereby certainly outputting the spindle control signal to the D/A converter 9. In contrast, when the output of the logical product circuit 21 is at the one logical value of “0”, the one end of the selector switch 20 is connected to the contact point D, thereby certainly outputting the FFh signal to the D/A converter 9.

Yet further, according to the present embodiment, since the spindle control signal to generate a positive drive force and the FFh signal are of a digital value, it can be easily performed that the most significant bit “0” of the spindle control signal and the most significant bit “1” of the FFh signal are extracted by the MSB extraction sections 101, 102 and stored in the latch circuits 201, 202, 203 and determined by the comparison controller 24.

Although in the present embodiment the latch circuits 201, 202, 203 are provided to store the signals output to the D/A converter 9 at three consecutive timings, the invention is not limited to this. For example, by increasing the number of latch circuits and raising the frequency of the clock signal, accuracy in the detection by the logical product circuit 21 and the logical sum circuit 22 is improved. Alternatively, with the number of latch circuits decreased, the detection by the logical product circuit 21 and the logical sum circuit 22 can be speeded up.

Although the preferred embodiment of the optical disk apparatus according to the present invention, particularly, the control of a spindle motor by the spindle control signal processing section has been described, the above embodiment is provided to facilitate the understanding of the present invention and not intended to limit the present invention. It should be understood that various changes and alterations can be made therein without departing from spirit and scope of the invention.

1. An optical disk apparatus comprising:
a controller that outputs a rotation control signal to rotate an optical disk medium rotating motor in a predetermined direction to a drive section that drives the rotating motor; and
a determining section that determines whether the rotation control signal has been continuously output for a first predetermined period of time based on information that has been read out from an optical disk medium when the optical disk medium is being rotated by the optical disk medium rotating motor,
wherein when the determining section determines that the rotation control signal has been continuously output for the first predetermined period of time, the controller stops the rotation control signal from being output for a second predetermined period of time on the basis of the determining result of the determining section.

2. The optical disk apparatus according to claim 1, wherein when the determining section determines that the rotation control signal has not been continuously output for the first predetermined period of time, the controller outputs the rotation control signal on the basis of the determining result of the determining section.

3. The optical disk apparatus according to claim 2, wherein when the determining section determines that the rotation control signal has been continuously output for the first predetermined period of time, the controller outputs to the drive section a drive force stop signal to stop the drive section from generating a drive force of the optical disk medium rotating motor for the second predetermined period of time on the basis of the determining result of the determining section.

4. The optical disk apparatus according to claim 3, wherein the determining section comprises:
a storage section that stores at plural timings respectively a plurality of output information pieces each indicating which of the rotation control signal and the drive force stop signal is output from the controller; and
a logic circuit that determines whether the rotation control signal has been output during the first predetermined period of time defined by the plural timings, on the basis of the plurality of output information pieces stored in the storage section.

5. The optical disk apparatus according to claim 4, wherein the logic circuit outputs one logical value if determining that the plurality of output information pieces stored in the storage section at the plural timings all indicate the rotation control signal, and the other logical value if determining that at least one of the plurality of output information pieces stored in the storage section does not indicate the rotation control signal, and
wherein the controller outputs to the drive section the drive force stop signal if the output of the logic circuit is the one logical value and the rotation control signal if the output of the logic circuit is the other logical value.

6. The optical disk apparatus according to claim 5, wherein the determining section comprises a comparison controller that determines whether the output of the logic circuit and the rotation control signal output from the controller at a timing following the plural timings are in a predetermined relationship,
wherein the controller comprises a selector that makes the rotation control signal or the drive force stop signal be output to the drive section depending on the determining result of the comparison controller, and
wherein if the output of the logic circuit is the one logical value, the controller makes the selector switch to the drive force stop signal to be output to the drive section on the basis of the determining result of the comparison controller and if the output of the logic circuit is the other logical value, the controller makes the selector switch to the rotation control signal to be output to the drive section on the basis of the determining result of the comparison controller.

7. The optical disk apparatus according to claim 6, wherein the rotation control signal and the drive force stop signal are of a digital value and the most significant bit of the rotation control signal is at the one logical value and the most significant bit of the drive force stop signal is at the other logical value,
wherein the determining section comprises:
a first extraction section that extracts the most significant bit of the rotation control signal or the drive force stop signal output through the selector; and
a second extraction section that extracts the most significant bit, being at the one logical value, of the rotation control signal output from the controller,
wherein the storage section stores at the plural timings the one logical value or the other logical value extracted by the first extraction section,
wherein when determining that only the one logical value has been stored in the storage section at the plural timings in the first predetermined period of time, the logic circuit outputs the one logical value, and when determining that the other logical value has been stored in the storage section at least at one timing, the logic circuit outputs the other logical value,
wherein the comparison controller compares a logical value output by the logic circuit and the output of the second extraction section, and
wherein the controller makes the selector switch to the rotation control signal or the drive force stop signal to be output to the drive section depending on the determining result of the comparison controller.

8. The optical disk apparatus according to claim 1, wherein when the determining section determines that the rotation control signal has been continuously output for the first predetermined period of time, the controller outputs to the drive section a reverse rotation control signal to rotate the optical disk medium rotating motor in a reverse direction to the predetermined direction for the second predetermined period of time on the basis of the determining result of the determining section.

9. The optical disk apparatus according to claim 8, wherein the determining section comprises:
a storage section that stores at plural timings respectively a plurality of rotation direction information pieces each indicating which of the rotation control signal and the reverse rotation control signal is output from the controller; and
a logic circuit that determines whether the rotation control signal has been output during the first predetermined period of time defined by the plural timings, on the basis of the plurality of rotation direction information pieces stored in the storage section.

10. The optical disk apparatus according to claim 9, wherein the logic circuit outputs one logical value if determining that the plurality of rotation direction information pieces stored in the storage section at the plural timings all indicate the rotation control signal, and the other logical value if determining that at least one of the plurality of rotation direction information pieces stored in the storage section does not indicate the rotation control signal, and
wherein the controller outputs to the drive section the reverse rotation control signal if the output of the logic circuit is the one logical value and the rotation control signal if the output of the logic circuit is the other logical value.

11. The optical disk apparatus according to claim 10, wherein the determining section comprises a comparison controller that determines whether the output of the logic circuit and the rotation control signal output from the controller at a timing following the plural timings are in a predetermined relationship,
wherein the controller comprises a selector that makes the rotation control signal or the reverse rotation control signal be output to the drive section depending on the determining result of the comparison controller, and
wherein if the output of the logic circuit is the one logical value, the controller makes the selector switch to the reverse rotation control signal to be output to the drive section on the basis of the determining result of the comparison controller and if the output of the logic circuit is the other logical value, the controller makes the selector switch to the rotation control signal to be output to the drive section on the basis of the determining result of the comparison controller.

12. The optical disk apparatus according to claim 11, wherein the rotation control signal and the reverse rotation control signal are of a digital value and the most significant bit of the rotation control signal is at the one logical value and the most significant bit of the reverse rotation control signal is at the other logical value,
wherein the determining section comprises:
a first extraction section that extracts the most significant bit of the rotation control signal or the reverse rotation control signal output through the selector; and
a second extraction section that extracts the most significant bit, being at the one logical value, of the rotation control signal output from the controller,
wherein the storage section stores at the plural timings the one logical value or the other logical value extracted by the first extraction section,
wherein when determining that only the one logical value has been stored in the storage section at the plural timings in the first predetermined period of time, the logic circuit outputs the one logical value, and when determining that the other logical value has been stored in the storage section at least at one timing, the logic circuit outputs the other logical value,
wherein the comparison controller compares a logical value output by the logic circuit and the output of the second extraction section, and
wherein the controller makes the selector switch to the rotation control signal or the reverse rotation control signal to be output to the drive section depending on the determining result of the comparison controller.

13. The optical disk apparatus according to claim 2, wherein when the determining section determines that the rotation control signal has been continuously output for the first predetermined period of time, the controller outputs to the drive section a reverse rotation control signal to rotate the optical disk medium rotating motor in a reverse direction to the predetermined direction for the second predetermined period of time on the basis of the determining result of the determining section.

14. The optical disk apparatus according to claim 13, wherein the determining section comprises:
a storage section that stores at plural timings respectively a plurality of rotation direction information pieces each indicating which of the rotation control signal and the reverse rotation control signal is output from the controller; and
a logic circuit that determines whether the rotation control signal has been output during the first predetermined period of time defined by the plural timings, on the basis of the plurality of rotation direction information pieces stored in the storage section.

15. The optical disk apparatus according to claim 14, wherein the logic circuit outputs one logical value if determining that the plurality of rotation direction information pieces stored in the storage section at the plural timings all indicate the rotation control signal, and the other logical value if determining that at least one of the plurality of rotation direction information pieces stored in the storage section does not indicate the rotation control signal, and
wherein the controller outputs to the drive section the reverse rotation control signal if the output of the logic circuit is the one logical value and the rotation control signal if the output of the logic circuit is the other logical value.

16. The optical disk apparatus according to claim 15, wherein the determining section comprises a comparison controller that determines whether the output of the logic circuit and the rotation control signal output from the controller at a timing following the plural timings are in a predetermined relationship,
wherein the controller comprises a selector that makes the rotation control signal or the reverse rotation control signal be output to the drive section depending on the determining result of the comparison controller, and
wherein if the output of the logic circuit is the one logical value, the controller makes the selector switch to the reverse rotation control signal to be output to the drive section on the basis of the determining result of the comparison controller and if the output of the logic circuit is the other logical value, the controller makes the selector switch to the rotation control signal to be output to the drive section on the basis of the determining result of the comparison controller.

17. The optical disk apparatus according to claim 16, wherein the rotation control signal and the reverse rotation control signal are of a digital value and the most significant bit of the rotation control signal is at the one logical value and the most significant bit of the reverse rotation control signal is at the other logical value,
wherein the determining section comprises:
a first extraction section that extracts the most significant bit of the rotation control signal or the reverse rotation control signal output through the selector; and
a second extraction section that extracts the most significant bit, being at the one logical value, of the rotation control signal output from the controller,
wherein the storage section stores at the plural timings the one logical value or the other logical value extracted by the first extraction section,
wherein when determining that only the one logical value has been stored in the storage section at the plural timings in the first predetermined period of time, the logic circuit outputs the one logical value, and when determining that the other logical value has been stored in the storage section at least at one timing, the logic circuit outputs the other logical value,
wherein the comparison controller compares a logical value output by the logic circuit and the output of the second extraction section, and
wherein the controller makes the selector switch to the rotation control signal or the reverse rotation control signal to be output to the drive section depending on the determining result of the comparison controller.
